(19) United States
(12) Patent Application Publication
(10) Pub. No.: US 2024/0020406 A1
(43) Pub. Date: Jan. 18, 2024

(54) METHOD AND APPARATUS FOR PROCESSING DATA, STORAGE MEDIUM AND DEVICE

(71) Applicant: SHANGHAI WEILIAN INFORMATION TECHNOLOGY CO., LTD., Shanghai (CN)

(72) Inventors: Jianliang GU, Shanghai (CN); Yang LU, Shanghai (CN)

(21) Appl. No.: 18/254,724

(22) PCT Filed: Sep. 3, 2021
(86) PCT No.: PCT/CN2021/116414

§ 371 Date: May 26, 2023

(30) Foreign Application Priority Data
Dec. 4, 2020 (CN) 202011406469.7

(51) Int. Cl. G06F 21/62

(52) U.S. Cl. CPC G06F 21/6218

(57) ABSTRACT

A method and an apparatus for processing data, a storage medium, and a device. When processing data of a product, production data that is of the product and within an enterprise is acquired, circulation data that is of the product and among enterprises is acquired, and then the acquired production data is correlated with the acquired circulation data based on data authorization and data reference, so as to obtain a chain of data relationship. Thereby, the data relationship is protected from being forged or tampered, and data query and data tracing are facilitated, which improves data security. In addition, data collaboration within the enterprise and among the enterprises can be effectively implemented. Further, visualization based on the data collaboration is capable to help recall the product accurately and efficiently.

The present disclosure claims the priority to Chinese Patent Application No. 202011406469.7, titled “METHOD AND APPARATUS FOR PROCESSING DATA, STORAGE MEDIUM AND DEVICE”, filed on Dec. 4, 2020 with the China National Intellectual Property Administration, which is incorporated herein by reference in its entirety

### FIELD

The present disclosure relates to the technical field of block chains, and in particular

to a method and an apparatus for processing data, a storage medium, and a device.

### BACKGROUND

The “data island” phenomenon goes increasingly apparent with development of big data technology, because data have features such as huge structural differences, various sources, low value densities, and real-time updates. Information systems are not sound within an enterprise and not compatible between enterprises, especially in scenarios such as a supply chain. Hence, it is difficult to share data effectively among different departments or different projects within an enterprise, and it is also difficult to achieve quick and united data collaboration, such as data sharing or data tracing, on information among enterprises.

Currently, there are two manners of data sharing within an enterprise. In a first manner, a data owner exports a to-be-shared file into a content format, which is identifiable to a data user, and transmits the file to the data user offline. In a second manner, a data owner stores a file, which is to be shared and to be exported, into a shared storage server (where the server is accessible for a data user, and is provided with permission control to prevent data leakage), and the data user fetches the file for processing. Further, there are three manners of data sharing among enterprises. In a first manner, a data owner exports a to-be-shared file into a content format, which is identifiable to a data user, and transmits the file to the data user offline. In a second manner, a data owner stores a file, which is to be shared and to be exported, into a shared storage server (where the server is accessible for a data user, and is provided with permission control to prevent data leakage), and the data user fetches the file for processing. In a third manner, a data owner or a data user opens a system application programming interface (API), and transmits required data after the data user or the data owner accesses the API. No actual relationship is established among data in the forgoing manners for data sharing within the enterprise or between the enterprises. Rather, the relationship is merely established at a logic level for the data, and a position of the data in a data chain and information on upstream and downstream circulations are not recorded in the data. Therefore, the data is isolated once such relationship is missing. A reason lies in that the data includes no information on upstream and downstream circulations of itself in the data chain. Accordingly, a relationship for the data can be forged or tampered, and cannot be queried and traced, resulting in low data security.

### SUMMARY

A method and an apparatus for processing data, a storage medium, and a device are provided according to embodiments of the present disclosure. The technical solutions are capable to correlate production data of a product, which is within an enterprise, with circulation data of the product, which are between enterprises, through data authorization and data reference, so as to obtain a chain of data relationship. Hence, the data relationship is protected from being forged or tampered, and data query and data tracing are facilitated, which improves the data security.

In a first aspect, a method for processing data is provided according to an

embodiment of the present disclosure. The method includes: acquiring production data that is of a product and within an enterprise; acquiring circulation data that is of the product and among enterprises; and correlating the production data with the circulation data through data authorization and data reference, to obtain a chain of data relationship.

In an embodiment, after acquiring the circulation data that is of the product and

among the enterprises, the method further includes: performing the data authorization among different departments of the enterprise or different projects of the enterprise, according to the production data; and performing the data authorization among systems of different ones of the enterprises, according to the circulation data.

In an embodiment, after acquiring the circulation data that is of the product and

among the enterprises, the method further includes: correlating different pieces of the production data at a level of data content, through the data reference, to achieve reference among data or codes within the enterprise; and correlating different pieces of the circulation data at the level of data content, through the data reference, to achieve reference among data or codes of different ones of the enterprises.

In an embodiment, after correlating the production data with the circulation data

based on the data authorization and the data reference to obtain the chain of data relationship, the method further includes: visualizing the chain of data relationship, to obtain visual data.

In an embodiment, the method further includes: tracing a source and a destination of circulation of the product, via the visual data.

In a second aspect, an apparatus for processing data is further provided according to

an embodiment of the present disclosure. The apparatus includes a first acquisition unit, a second acquisition unit and a first obtaining unit. The first acquisition unit is configured to acquire production data that is of a product and within an enterprise. The second acquisition unit is configured to acquire circulation data that is of the product and among enterprises. The first obtaining unit is configured to correlate the production data with the circulation data through data authorization and data reference, to obtain a chain of data relationship.

In an embodiment, the apparatus further includes a first authorization unit and a second authorization unit. The first authorization unit is configured to perform the data authorization among different departments of the enterprise or different projects of the enterprise, according to the production data. The second authorization unit is configured to perform the data authorization among systems of different ones of the enterprises, according to the circulation data.

In an embodiment, the apparatus further includes a first correlation unit and a second correlation unit. The first correlation unit is configured to correlate different pieces of the production data at a level of data content, through the data reference, to achieve reference among data or codes within the enterprise. The second correlation unit is configured to correlate different pieces of the circulation data at the level of data content, through the data reference, to achieve reference among data or codes of different ones of the enterprises.

In an embodiment, the apparatus further includes a second obtaining unit. The second obtaining unit is configured to visualize the chain of data relationship, to obtain visual data.

In an embodiment, the apparatus further includes a tracing unit. The tracing unit is configured to trace a source and a destination of circulation of the product, via the visual data.

A device for processing data is further provided according to an embodiment of the present disclosure. The device includes a processor, a memory and a system bus. The processor is coupled to the memory via the system bus. The memory is configured to store one or more programs. The one or more programs include instructions, and the instructions when executed by the processor configure the processor to perform any forgoing method for processing data.

A computer-readable storage medium is further provided according to an

embodiment of the present disclosure. The computer-readable storage medium stores instructions. The instructions when running on a terminal device configure the terminal device performs any forgoing method for processing data.

A method and an apparatus for processing data, a storage medium, and a device are provided according to the embodiments of the present disclosure. When processing data of a product, the production data that is of the product and within the enterprise is acquired, the circulation data that is of the product and among the enterprises is acquired, and then the acquired production data is correlated with the acquired circulation data based on the data authorization and the data reference, so as to obtain the chain of data relationship. Thereby, the data relationship is protected from being forged or tampered, and data query and data tracing are facilitated, which improves data security. In addition, data collaboration within the enterprise and among the enterprises can be effectively implemented. Further, visualization based on the data collaboration is capable to help recall the product accurately and efficiently.

### BRIEF DESCRIPTION OF THE DRAWINGS

For clearer illustration of the technical solutions according to embodiments of the present disclosure or conventional techniques, hereinafter briefly described are the drawings to be applied in embodiments of the present disclosure or conventional techniques. Apparently, the drawings in the following descriptions are only some embodiments of the present disclosure, and other drawings may be obtained by those skilled in the art based on the provided drawings without creative efforts.

FIG. 1 is a schematic flow chart of a method for processing data according to an embodiment of the present disclosure;

FIG. 2 is a schematic diagram of a chain of data relationship according to an embodiment of the present disclosure;

FIG. 3 is a schematic diagram for tracing a source and a destination of circulation of a product according to an embodiment of the present disclosure; and

FIG. 4 is a schematic structural diagram an apparatus for processing data according to an embodiment of the present disclosure.

### DETAILED DESCRIPTION

In scenarios such as a supply chain, current information systems are not sound within an enterprise and not compatible between enterprises. Hence, it is difficult to share data effectively among different departments or different projects within an enterprise, and it is also difficult to achieve a quick and united collaboration on information among enterprises.

Specifically, in embodiments of the present disclosure, an owner of data is defined as a “data owner”, and a party for which the data is shared is defined as a “data user”. On such basis, there are two manners of data sharing within an enterprise. In a first manner, a data owner exports a to-be-shared file into a content format, which is identifiable to a data user, and transmits the file to the data user offline. In a second manner, a data owner stores a file, which is to be shared and to be exported, into a shared storage server (where the server is accessible for a data user, and is provided with permission control to prevent data leakage), and the data user fetches the file for processing.

Further, there are three manners of data sharing among enterprises. In a first manner, a data owner exports a to-be-shared file into a content format, which is identifiable to a data user, and transmits the file to the data user offline. In a second manner, a data owner stores a file, which is to be shared and to be exported, into a shared storage server (where the server is accessible for a data user, and is provided with permission control to prevent data leakage), and the data user fetches the file for processing. In a third manner, a data owner or a data user opens a system application programming interface (API), and transmits required data after the data user or the data owner accesses the API.

No actual relationship is established among data in the forgoing manners for data sharing within the enterprise or between the enterprises. Rather, the relationship is merely established at a logic level for the data, and a position of the data in a data chain and information on upstream and downstream circulations are not recorded in the data. Therefore, the data is isolated once such relationship is missing. A reason lies in that the data includes no information on upstream and downstream circulations of itself in the data chain. Accordingly, a relationship for the data can be forged or tampered, and cannot be queried and traced, resulting in low data security.

In order to address the above deficiencies, a method and an apparatus for processing data, a storage medium, and a device are provided according to embodiments of the present disclosure. When processing data of a product, production data that is of a product and within an enterprise is acquired, circulation data that is of the product and among enterprises is acquired, and then the acquired production data is correlated with the acquired circulation data based on data authorization and data reference, so as to obtain a chain of data relationship. Thereby, the data relationship is protected from being forged or tampered, and data query and data tracing are facilitated, which improves data security. In addition, data collaboration within the enterprise and among the enterprises can be effectively implemented. Further, visualization based on the data collaboration is capable to help recall the product accurately and efficiently.

In order to make the object, technical solutions and advantages of the present application clearer, hereinafter technical solutions in embodiments of the present disclosure are described clearly and completely in conjunction with the drawings in embodiments of the present closure. Apparently, the described embodiments are only some rather than all of the embodiments of the present disclosure. Any other embodiments obtained based on the embodiments of the present disclosure by those skilled in the art without any creative effort fall within the scope of protection of the present disclosure.

### First Embodiment

Reference is made to FIG. 1, which is a schematic flow chart of a method for processing data according to an embodiment of the present disclosure. The method includes following steps S101 to S103.

In step S101, production data that is of a product and within an enterprise is acquired.

In this embodiment, the production data that is of the product and within the enterprise is first acquired, and the production data is for subsequent step S103, in order to protect a data relationship from being forged or tampered, facilitate data query and data tracing, and improve data security.

The production data may be data concerning a raw material for producing the product. Wine is taken as an example. During producing the wine, a supplier should gather grapes as the raw material, purchase wine bottles as containers, and the like. The raw material and the wine bottles may be purchased by different departments or different project groups within the supplier. Data concerning the above belongs to the production data that is of the product (that is, the wine) and within the enterprise (that is, the supplier).

In step S102, circulation data that is of the product and among enterprises is acquired.

In the embodiment, it is necessary to not only acquire the production data that is of the product and within the enterprise in step S101, but also acquire the circulation data that is of the product and among the enterprises. Both the production data and the circulation data are for subsequent step S103, in order to protect a data relationship from being forged or tampered, facilitate data query and data tracing, and improve data security.

The circulation data refers to various description data, which concerns the product and is generated when the product circulates (for example, being delivered, transferred, or received) between an upstream enterprise and a downstream enterprise. Wine is further taken as an example. When delivering produced wine to a retailer, a winery may send production data concerning the wine, along with the wine, to the retailer. The production data may be in a specific data format (such as a hash value corresponding to the production data), and serve as delivery information. Thereby, the retailer receives the delivery information when receiving the wine. Afterwards, in a case that the retailer resells the wine to a downstream node, such as another retailer or a customer, the retailer sends the previous delivery information, which is received from upstream, and current delivery information along with the wine. When receiving the wine, the other retailer or the customer, as the downstream node, receives information on all upstream sources of the wine. All data generated in the circulation, from the winery to the retailer and from the retailer to the other retailer or the customer, may be called the circulation data among the enterprises.

In an embodiment of the present disclosure, after acquiring the production data and the circulation data, the method further includes following steps A1 and A2.

In step A1, the data authorization is performed among different departments of the enterprise or different projects of the enterprise, according to the production data.

In step A2, the data authorization is performed among systems of different ones of the enterprises, according to the circulation data.

Specifically, since the data owner has a right to control data, the data owner can authorize the data to a corresponding target party. The target may be another department or another project of the enterprise, or may be a third-party enterprise. Such authorization may be cancelled at any time, and content of the authorization may be chosen. Therefore, after acquiring the production data that is of the product and within the enterprise, the data authorization is further performed among different departments or different projects of the enterprise according to the production data, through relevant technology. In addition, after acquiring the circulation data that is of the product and among the enterprises, the data authorization is further performed among systems of different enterprises according to the circulation data, through relevant technology. Hence, a global service is established. Moreover, granularity of the authorized data may be configured in items of the data.

In an embodiment of the present disclosure, after acquiring the production data and the circulation data, the method further includes following steps B1 and B2.

In step B1, different pieces of the production data is correlated at a level of data content, through the data reference, to achieve reference among data or codes within the enterprise. In step B2, different pieces of the circulation data is correlated at the level of data

content, through the data reference, to achieve reference among data or codes of different ones of the enterprises.

Specifically, data can be correlated within the enterprise through a technology relevant to the data reference, and data can be shared and correlated among the enterprises through a technology relevant to the data reference. An objective of the data reference is achieving correlation at the level of data content, for the above two types of data. Further, the data reference need not establish additional relationship for the above two types of data. The data reference adopted in this embodiment may include two parts. A first part is configured to implement reference among the data, for example, reference at a receiving node to data of a delivery node. Such data may be, for example, information on an order for goods. In such case, a downstream node may acquire desensitized information on the order after parsing the data, and cannot further acquire detailed information on a source of the goods until acquiring authorization from a relevant upstream enterprise. The above scenario may be widely applied to online operations. A second part is configured to implement reference among the codes. For example, a receiving node implements reference to a code of delivered goods by scanning the code. For example, a code attached to the goods is scanned to acquire information on an order. In such case, a downstream node may acquire desensitized information on the order after scanning and parsing the code, and cannot further acquire detailed information on a source of the goods until acquiring authorization from a relevant upstream enterprise. The above scenario may be widely applied to offline operations.

In step S103, the production data is correlated with the circulation data through data authorization and data reference, to obtain a chain of data relationship.

In the embodiment, after acquiring the production data in step S101 and acquiring the circulation data in step S102, the chain of data relationship is further obtained by correlating the production data with the circulation data through the data authorization technology and the data reference. Moreover, in this embodiment, big data technology is adopted to form the data chain, since data concerning business process of the enterprise(s) is large in amount, complex in relationships, and even more complex in traceability. That is, a technology relevant to data relationships concerns constructing a relationship among the data of the enterprise(s). Thereby, at least one of three key functions may be achieved, i.e., a data relationships can be conveniently and quickly obtained from a search conducted at a node in a business process, a tracing path can be obtained from a search based on two data nodes, or it can be determined whether there is a loop in a data chain.

In one embodiment, the chain of data relationship may be visualized to obtain visual data, after the production data is correlated with the circulation data through the data authorization and the data reference to obtain the chain of data relationship. Thereby, a source and a destination of circulation of the product may be traced via the visual data.

In this embodiment, after establishing a data chain for production of the enterprise and a data chain for tracing among the enterprises, these data chains may be further applied to a scenario utilizing, for example, data visualization, in order to trace the source and the destination of circulation of the product. For example, the scenario may be a food recall. In addition, two different perspectives, i.e., a raw material perspective and a tracing perspective, may be further provided for the data visualization according to embodiments of the present disclosure. Hence, an enterprise may visually present a source and a destination of circulation of the product with respect to raw materials of the product, the product within the enterprise, and the tracing among enterprises. Thereby, a source of the product can be traced, a destination of the product can be verified, and a relevant responsibility can be investigated.

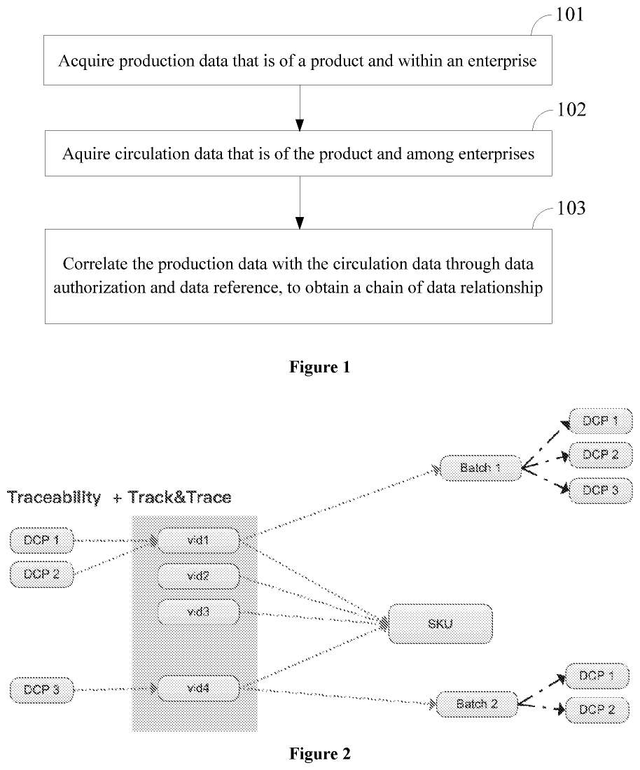

As an example, FIG. 2 shows a schematic diagram of a chain of data relationship according to an embodiment of the present disclosure. “DCP” in FIG. 2 represents a data collection point, such as a delivery node or a receiving node among the traceable nodes. “Batch” represents a batch node, that is, a batch which may bind different DCPs as a whole. “SKU” represents a category of the product. “Vid” represents an identifier of a single product, and different identifiers correspond to different objects. Thereby, the vid, the SKU, and the batch may be correlated with each other through an operation of binding based on the SKU. A directions of an arrow in FIG. 2 indicates a relationship. The SKU to which the vid belongs, the Batch in which the vid is located in production, and the DCP via which the vid passes in tracing, can be clearly recognized through the relationship. Hence, the traceability of the product is achieved.

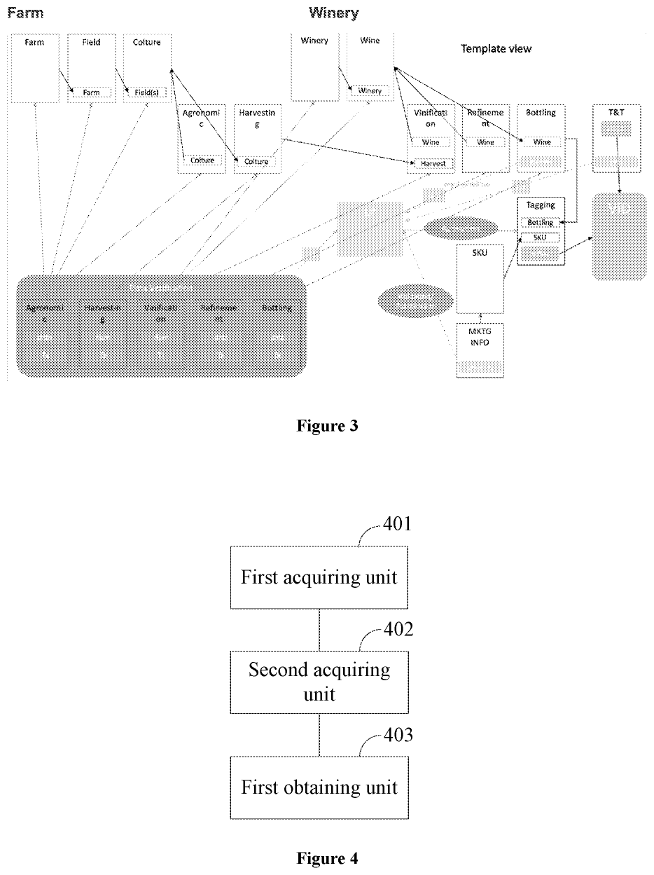

As another example, FIG. 3 shows a schematic diagram for tracing a source and a destination of circulation of a product according to an embodiment of the present disclosure. The schematic diagram in FIG. 3 illustrates data collaboration among enterprises the produce wine. “Farm” represents an enterprise providing a farm, and “Winery” represents a winery. Data related to circulation may be generated when the wine circulates between the farm and the winery, as indicated by arrows in FIG. 3. Thereby, a chain of data relationship formed through the forging method may be applied in visualization, query and tracing. The data relationship can be effectively protected from being forged and tampered, improving data security concerning the wine.

In summary, the method for processing data is provided according to the above embodiments. When processing data of a product, the production data that is of the product and within the enterprise is acquired, the circulation data that is of the product and among the enterprises is acquired, and then the acquired production data is correlated with the acquired circulation data based on the data authorization and the data reference, so as to obtain the chain of data relationship. Thereby, the data relationship is protected from being forged or tampered, and data query and data tracing are facilitated, which improves data security. In addition, data collaboration within the enterprise and among the enterprises can be effectively implemented. Further, visualization based on the data collaboration is capable to help recall the product accurately and efficiently.

### Second Embodiment

An apparatus for processing data is provided according to an embodiment. Relevant content may refer to the foregoing method embodiments.

Reference is made to FIG. 4, which is a schematic structural diagram of an apparatus for processing data according to an embodiment of the present disclosure. The apparatus includes a first acquisition unit 401, a second acquisition unit 402 and a first obtaining unit 403. The first acquisition unit 401 is configured to acquire production data that is of a product and within an enterprise. The second acquisition unit 402 is configured to acquire circulation data that is of the product and among enterprises. The first obtaining unit 403 is configured to correlate the production data with the circulation data through data authorization and data reference, to obtain a chain of data relationship.

In an embodiment, the apparatus further includes a first authorization unit and a second authorization unit. The first authorization unit is configured to perform the data authorization among different departments of the enterprise or different projects of the enterprise, according to the production data. The second authorization unit is configured to perform the data authorization among systems of different ones of the enterprises, according to the circulation data.

In an embodiment, the apparatus further includes a first correlation unit and a second correlation unit. The first correlation unit is configured to correlate different pieces of the production data at a level of data content, through the data reference, to achieve reference among data or codes within the enterprise. The second correlation unit is configured to correlate different pieces of the circulation data at the level of data content, through the data reference, to achieve reference among data or codes of different ones of the enterprises.

In an embodiment, the apparatus further includes a second obtaining unit. The second obtaining unit is configured to visualize the chain of data relationship, to obtain visual data.

In an embodiment, the apparatus further includes a tracing unit. The tracing unit is configured to trace a source and a destination of circulation of the product, via the visual data.

In summary, the apparatus for processing data is provided according to the above embodiments. When processing data of a product, the production data that is of the product and within the enterprise is acquired, the circulation data that is of the product and among the enterprises is acquired, and then the acquired production data is correlated with the acquired circulation data based on the data authorization and the data reference, so as to obtain the chain of data relationship. Thereby, the data relationship is protected from being forged or tampered, and data query and data tracing are facilitated, which improves data security. In addition, data collaboration within the enterprise and among the enterprises can be effectively implemented. Further, visualization based on the data collaboration is capable to help recall the product accurately and efficiently.

Furthermore, a device for processing data is provided according to an embodiment of the present disclosure. The device includes a processor, a memory and a system bus. The processor is coupled to the memory via the system bus. The memory is configured to store one or more programs. The one or more programs include instructions, and the instructions when executed by the processor configure the processor to perform any forgoing method for processing data.

Furthermore, a computer-readable storage medium is provided according to an embodiment of the present disclosure. The computer-readable storage medium stores instructions. The instructions when running on a terminal device configure the terminal device performs any forgoing method for processing data.

From description of the foregoing embodiments, those skilled in the art can clearly understand that all or a part of the foregoing embodiment may be implemented by means of software plus a necessary common hardware platform. Based on such understanding, an essence or a part contributing to conventional technology, of the above technical solutions may be implemented as a software product. The computer software product may be stored in a storage medium such as a ROM/RAM, a disk, an optical disk. The computer software product includes instructions for controlling a computing device (for example, a personal computer, a server, or a network communication device such as a media gateway) to perform the method described in each embodiment of the present disclosure or a part of each embodiment of the present disclosure.

The embodiments of the present disclosure are described in a progressive manner, and each embodiment places emphasis on the difference from other embodiments. Therefore, one embodiment can refer to other embodiments for the same or similar parts. Since apparatuses disclosed in the embodiments correspond to methods disclosed in the embodiments, the description of the apparatuses is simple, and reference may be made to the relevant part of the methods.

It should be noted that, the relationship terms such as “first”, “second” and the like are only used herein to distinguish one entity or operation from another, rather than to necessitate or imply that an actual relationship or order exists between the entities or operations. Furthermore, the terms such as “include”, “comprise” or any other variants thereof means to be non-exclusive. Therefore, a process, a method, an article or a device including a series of elements include not only the disclosed elements but also other elements that are not clearly enumerated, or further include inherent elements of the process, the method, the article or the device. Unless expressively limited, the statement “including a . . . ” does not exclude the case that other similar elements may exist in the process, the method, the article or the device other than enumerated elements.

According to the description of the disclosed embodiments, those skilled in the art can implement or use the present disclosure. Various modifications made to these embodiments may be obvious to those skilled in the art, and the general principle defined herein may be implemented in other embodiments without departing from the spirit or scope of the present disclosure. Therefore, the present disclosure is not limited to the embodiments described herein but confirms to a widest scope in accordance with principles and novel features disclosed in the present disclosure.

1. A method for processing data, comprising:
acquiring production data that is of a product and within an enterprise;
acquiring circulation data that is of the product and among enterprises; and
correlating the production data with the circulation data through data authorization and data reference, to obtain a chain of data relationship.

2. The method according to claim 1, wherein after acquiring the production data and acquiring the circulation data, the method further comprises:
performing the data authorization among different departments of the enterprise or different projects of the enterprise, according to the production data; and
performing the data authorization among systems of different ones of the enterprises, according to the circulation data.

3. The method for processing data according to claim 1, wherein after acquiring the production data and acquiring the circulation data, the method further comprises:
correlating different pieces of the production data at a level of data content, through the data reference, to achieve reference among data or codes within the enterprise; and
correlating different pieces of the circulation data at the level of data content, through the data reference, to achieve reference among data or codes of different ones of the enterprises.

4. The method for processing data according to claim 1, wherein after correlating the production data with the circulation data based on the data authorization and the data reference to obtain the chain of data relationship, the method further comprises:
visualizing the chain of data relationship, to obtain visual data.

5. The method for processing data according to claim 4, further comprising:
tracing a source and a destination of circulation of the product, via the visual data.

6-11. (canceled)

12. A computer-readable storage medium, storing instructions, wherein:
the instructions when running on a terminal device configure the terminal device performs the method according to claim 1.

13. An apparatus for processing data, comprising a memory and a processor, wherein the memory stores computer-readable instructions, and the computer-readable instructions when executed by the processor configure the apparatus to perform:
acquiring production data that is of a product and within an enterprise;
acquiring circulation data that is of the product and among enterprises; and
correlating the production data with the circulation data through data authorization and data reference, to obtain a chain of data relationship.

14. The apparatus according to claim 13, wherein after acquiring the production data and acquiring the circulation data, the computer-readable instructions when executed by the processor configure the apparatus to further perform:
performing the data authorization among different departments of the enterprise or different projects of the enterprise, according to the production data; and
performing the data authorization among systems of different ones of the enterprises, according to the circulation data.

15. The apparatus for processing data according to claim 13, wherein after acquiring the production data and acquiring the circulation data, the computer-readable instructions when executed by the processor configure the apparatus to further perform:
correlating different pieces of the production data at a level of data content, through the data reference, to achieve reference among data or codes within the enterprise; and
correlating different pieces of the circulation data at the level of data content, through the data reference, to achieve reference among data or codes of different ones of the enterprises.

16. The method for processing data according to claim 13, wherein after correlating the production data with the circulation data based on the data authorization and the data reference to obtain the chain of data relationship, the computer-readable instructions when executed by the processor configure the apparatus to further perform:
visualizing the chain of data relationship, to obtain visual data.

17. The method for processing data according to claim 16, wherein the computer-readable instructions when executed by the processor configure the apparatus to further perform:
tracing a source and a destination of circulation of the product, via the visual data.
